(19) United States
(12) Patent Application Publication
(10) Pub. No.: US 2025/0315708 A1
(43) Pub. Date: Oct. 9, 2025

(54) MULTI-PLANE DIFFERENTIAL QUADRUPOLE FLUX BIAS COIL

(71) Applicant: INTERNATIONAL BUSINESS MACHINES CORPORATION, ARMONK, NY (US)

(72) Inventor: Joseph Robert Suttle, Chappaqua, NY (US)

(21) Appl. No.: 18/332,704

(22) Filed: Jun. 9, 2023

(51) Int. Cl. G06N 10/40; H01F 27/28; H01F 27/34

(52) U.S. Cl. CPC G06N 10/40; H01F 27/28; H01F 27/34

(57) ABSTRACT

A quantum structure includes a flux bias coil having a first inductive element and a second inductive element. A magnetic induction of the first inductive element is opposite to a magnetic induction of the second inductive element. A superconducting quantum interference device (SQUID) is within a footprint of the first inductive element. A first flux bias line is coupled to the first inductive element and a second flux bias line is coupled to the second inductive element. A routing of the first and second flux bias lines is on one or more planes separate from the flux bias coil.

### BACKGROUND

### Technical Field

The present disclosure generally relates to the field of quantum computing, and more specifically, to multi-plane differential quadrupole flux bias control of qubits in quantum circuits.

### Description of the Related Art

Superconducting quantum computing is an implementation of a quantum computer in superconducting electronic circuits. Quantum computation studies the application of quantum phenomena for information processing and communication. Various models of quantum computation exist, and the most popular models include the concepts of qubits and quantum gates. A qubit is a generalization of a bit that has two possible states, but can be in a quantum superposition of both states. A quantum gate is a generalization of a logic gate, however the quantum gate describes the transformation that one or more qubits will experience after the gate is applied on them, given their initial state. A quantum architecture is often configured in two dimensions, and it can be challenging to implement the processing architecture for a quantum computer in a limited amount of available space. Further, many quantum phenomena, such as superposition and entanglement, do not have analogs in the world of classical computing and therefore may involve special structures, techniques, and materials.

In quantum processors that use flux tunable elements, there are myriad ways to bring in the biasing flux used to tune them in situ. In cases that involve individual control of different tunable elements on chip, these designs are usually some type of small coil routed into/onto the processor itself. It is salient that coils of these kinds minimize crosstalk to other flux sensitive components that may be located nearby on the chip. In some cases, these flux lines support relatively rapid changes in external flux bias. These flux bias signals typically, but not always, have a bandwidth of <1 GHz. In order to support these time varying flux pulses, it is desirable that the flux coils reduce (e.g., minimize) sources of parasitic inductance and capacitance as much as possible, as these parasitic can introduce significant time domain distortion/dispersion to the applied flux pulses.

### SUMMARY

According to an embodiment, a structure includes a (e.g., counter-wound) flux bias coil having a first inductive element and a second inductive element, wherein a magnetic induction of the first inductive element is opposite to a magnetic induction of the second inductive element. There may be a first through silicon via (TSV) or landing pad coupled to the first inductive element and a second TSV or landing pad coupled to the second inductive element. A superconducting quantum interference device (SQUID) is within a footprint of (e.g., around, within, and/or overlapping) the first inductive element. A first flux bias line is coupled to the first inductive element. A second flux bias line is coupled to the second inductive element. A routing of the first and second flux bias lines is on one or more planes separate from the flux bias coil. The present structure reduces crosstalk between qubits and reduces parasitics which can distort flux bias pulses.

In one embodiment, which can be combined with the preceding embodiment, the first inductive element is in series with the second inductive element. The second inductive element provides a return path for the current while providing a magnetic field that is in opposite direction to the first inductive element.

In one embodiment, which can be combined with the preceding embodiments, a number of loops in each inductive coil is greater than 1. The higher the number of coils, the more inductance and magnetic field can be achieved. Since separate planes are used between the coils and the flux bias lines leading thereto, the number of loops that can be implemented is not impeded.

In one embodiment, which can be combined with the preceding embodiments, the first inductive element is on a first plane and the second inductive element is on a second plane that is separate from the first plane.

In one embodiment, which can be combined with the preceding embodiments, the first plane is on a first substrate and the second plane is on a second substrate.

In one embodiment, which can be combined with the preceding embodiments, a first TSV (or landing pad) coupled to the first inductive element and a second TSV (or landing pad) coupled to the second inductive element, are each on a plane that is separate from the first and second bias lines coupled to the first and second landing pads, respectively. Such separation allows easier and more symmetric access to the corresponding landing pads.

In one embodiment, which can be combined with the preceding embodiments, the structure is configured to be controlled differentially. Differential operation facilitates better noise immunity.

In one embodiment, which can be combined with the preceding embodiments, structure is configured to be operated in a cryogenic environment.

In one embodiment, which can be combined with the preceding embodiments, the SQUID encompasses the first inductive element but not the second inductive element.

In one embodiment, the SQUID encompasses both the first inductive element and the second inductive element. In this way, the magnetic field of both the first inductive element and the second inductive element can be harnessed.

In one embodiment, the SQUID has a twist at a center portion of its loop to create a quadrupole field. By virtue of the twist in the SQUID loop, both halves of the induced magnetic field of the bias current can be used (e.g., thereby providing a doubling effect of the magnetic field instead of a cancellation effect).

In one embodiment, which can be combined with the preceding embodiments, the first and second flux bias lines are each placed between a first ground layer and a second ground layer. Such isolation provides better shielding of the bias currents.

According to one embodiment, a tunable qubit device includes a (e.g., counter-wound) flux bias coil having a first inductive element and a second inductive element, wherein a magnetic induction of the first inductive element is opposite to a magnetic induction of the second inductive element. A superconducting quantum interference device (SQUID) is around the first inductive element. A first flux bias line is coupled to the first inductive element. A second flux bias line is coupled to the second inductive element. A routing of the first and second flux bias lines is on one or more planes separate from the flux bias coil. The present structure reduces crosstalk between qubits, reduces flux bias pulse distortion from parasitics, and is ultimately more resilient against quantum decoherence. Further, more symmetric routing to the indictive elements is facilitated, which does not impede the number of loops that can be used for each inductive element.

In one embodiment, which can be combined with the preceding embodiment, the first inductive element is in series with the second inductive element.

In one embodiment, which can be combined with the preceding embodiments, the first inductive element is on a first plane and the second inductive element is on a second plane that is separate from the first plane.

In one embodiment, which can be combined with the preceding embodiments, the structure is configured to be controlled differentially.

In one embodiment, which can be combined with the preceding embodiments, the structure is quantum structure and configured to be operated in a cryogenic environment.

In one embodiment, the SQUID encompasses both the first inductive element and the second inductive element. The SQUID has a twist at a center portion of its loop to create a quadrupole field. By virtue of the twist in the SQUID loop, both halves of the induced magnetic field of the bias current can be used (e.g., thereby providing a doubling effect of the magnetic field instead of a cancellation effect).

According to one embodiment, a method of tuning a qubit device includes providing a (e.g., counter-wound) flux bias coil having a first inductive element and a second inductive element. A magnetic induction of the first inductive element is provided in a first direction. A magnetic induction of the second inductive element is provided in a second direction that is opposite to the first direction. A superconducting quantum interference device (SQUID) is provided in a footprint of the first inductive element. A current through a first flux bias line coupled to the first inductive element is provided. A return current through a second flux bias line coupled to the second inductive element is provided. The first and second flux bias lines are routed on one or more planes separate from the flux bias coil. In this way, crosstalk between qubits is reduced and better quantum decoherence is provided.

In one embodiment, which can be combined with the preceding embodiment, the first inductive element is coupled in series with the second inductive element.

In one embodiment, which can be combined with the preceding embodiments, the first inductive element is on a first plane and the second inductive element is on a second plane that is separate from the first plane.

In one embodiment, which can be combined with the preceding embodiments, the SQUID encompasses both the first inductive element and the second inductive element. A twist is provided at a center portion of a loop of the SQUID, to create a quadrupole field. By virtue of the twist in the SQUID loop, both halves of the induced magnetic field of the bias current can be used (e.g., thereby providing a doubling effect of the magnetic field instead of a cancellation effect).

According to one embodiment, a quantum computer device includes a refrigeration system under vacuum including a containment vessel. A qubit chip is housed within a refrigerated vacuum environment defined by the containment vessel. The qubit chip includes many tunable qubit devices. Many electromagnetic waveguides are arranged within the refrigerated vacuum environment configured to direct electromagnetic energy to and receive electromagnetic energy from at least a selected one of the plurality of tunable qubit devices. Each of the plurality of tunable qubit devices includes a (e.g., counter-wound) flux bias coil having a first inductive element and a second inductive element. An induction of the first inductive element is opposite to an induction of the second inductive element. There is a superconducting quantum interference device (SQUID) around the first inductive element. A first flux bias line is coupled to the first inductive element A second flux bias line is coupled to the second inductive element. A routing of the first and second flux bias lines is on one or more planes separate from the flux bias coil.

In one embodiment, which can be combined with the preceding embodiment, the first inductive element is in series with the second inductive element.

In one embodiment, which can be combined with the preceding embodiments, the first landing pad and the second landing pad are each on a plane that is separate from the first and second bias lines coupled to the first and second landing pads, respectively.

In one embodiment, which can be combined with the preceding embodiments, the SQUID encompasses both the first inductive element and the second inductive element. The SQUID has a twist at a center portion of its loop to create a quadrupole field.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1A illustrates a top view of an example structure that uses a differential drive and a counter-wound coil to achieve reduced parasitic interference between qubits, consistent with an illustrative embodiment.

FIG. 1B illustrates a side view of the structure of FIG. 1A, consistent with an illustrative embodiment.

FIG. 2 illustrates another architecture of a superconducting interference device, where the lower layer wiring is encased in ground planes, consistent with an illustrative embodiment.

FIG. 3 illustrates an alternative embodiment of a SQUID device having inductive elements with additional loops in each coil, consistent with an illustrative embodiment.

FIG. 4 illustrates a top view of a gradiometric SQUID device, consistent with an illustrative embodiment.

FIG. 5 provides a method of tuning a qubit device, consistent with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,“ “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a chip.

As used herein, the term “vertical,” “outside the page,” or “inside the page” relate to an orientation that is arranged perpendicular to the first surface of a chip, chip carrier, or semiconductor body.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used and structural or logical changes may be made without departing from the spirit and scope defined by the claims. The description of the embodiments is not limiting. In particular, elements of the embodiments described hereinafter may be combined with elements of different embodiments.

As used herein, certain terms are used indicating what may be considered an idealized behavior, such as, for example, “lossless,” “superconductor,” or “superconducting,” which are intended to cover functionality that may not be exactly ideal but is within acceptable margins for a given application. For example, a certain level of loss or tolerance may be acceptable such that the resulting materials and structures may still be referred to by these “idealized” terms.

The concepts herein relate to quantum technology and quantum chips. Regarding quantum technology, the electromagnetic energy associated with a qubit can be stored, for example, in so-called Josephson junctions and in the capacitive and inductive elements that are used to form the qubit. In other examples, there may be spin qubits coupled to resonators or topological qubits, microfabricated ion traps, etc.

In one example, to read out the qubit state, a microwave signal is applied to the microwave readout cavity that couples to the qubit at the cavity frequency. The transmitted (or reflected) microwave signal goes through multiple thermal isolation stages and low-noise amplifiers (LNAs) that are used to block or reduce the noise and improve the signal-to-noise ratio. Alternatively, or in addition, a microwave signal (e.g., pulse) can be used to entangle one or more qubits.

The amplitude and/or phase of the returned/output microwave signal carries information about the qubit state, such as whether the qubit has dephased to the ground or excited state. The microwave signal carrying the quantum information about the qubit state is usually weak (e.g., on the order of a few microwave photons). To measure this weak signal with room temperature electronics (i.e., outside a refrigerated environment), low-noise quantum-limited amplifiers (QLAs), such as Josephson amplifiers and travelling-wave parametric amplifiers (TWPAs), may be used as preamplifiers (i.e., first amplification stage) at the output of the quantum system to boost the quantum signal, while adding the minimum amount of noise as dictated by quantum mechanics, in order to improve the signal to noise ratio of the output chain. In addition to Josephson amplifiers, certain Josephson microwave components that use Josephson amplifiers or Josephson mixers such as Josephson circulators, Josephson isolators, and Josephson mixers can be used in scalable quantum processors. Accordingly, Josephson junctions are salient circuit elements of a superconducting quantum computer. A Josephson junction may include a thin layer of insulator, sometimes referred to as a barrier or a tunnel barrier, between two layers of superconductor. The Josephson junction acts as a superconducting tunnel junction.

Flux bias lines, microwave lines, drive lines, coupling resonators, and readout resonators, such as e.g., discussed herein, together may form interconnects for supporting propagation of microwave signals. Further, any other connections for providing direct electrical interconnection between different quantum circuit elements and components, such as connections from electrodes of Josephson Junctions to electrodes of the capacitors or to superconducting loops of superconducting quantum interference devices (SQUIDS) or connections between two ground lines of a transmission line for equalizing electrostatic potential on the two ground lines, are also referred to herein as interconnects. Still further, the term “interconnect” may also be used to refer to elements providing electrical interconnections between quantum circuit elements and components and non-quantum circuit elements, which may also be provided in a quantum circuit, as well as to electrical interconnections between various non-quantum circuit elements provided in a quantum circuit. Examples of non-quantum circuit elements which may be provided in a quantum circuit may include various analog and/or digital systems, such as analog to digital converters, amplifiers, mixers, multiplexers, etc.

Materials to make the interconnects discussed herein (sometimes referred to herein as flux bias lines or simply superconductors) may include, without limitation, niobium (Nb), aluminum (Al), niobium nitride (NbN), titanium nitride (TiN), niobium titanium nitride (NbTiN), etc. It will be understood that other suitable materials that have superconducting properties can be used as well.

The states of the qubits in a quantum computer can be described using wave functions, which are mathematical representations of the quantum state of the system. Coherence is present in a quantum computing system when a phase relation exists between the states of the quantum computer, such as a phase relation between the quantum wave functions that describes the qubit states. Quantum computers rely on coherence to operate. A loss of quantum coherence relates to a loss of information to the outside environment and is destructive to the computations being performed. Coherence can be maintained by isolation of the qubits in the quantum computer from outside noise, such as thermal interactions and electromagnetic interactions, cause the coherence of the system to degrade in a process called quantum decoherence. Thus, quantum decoherence can be interpreted as the loss of information from the quantum system into its surrounding environment.

As used herein, the term “persistent” includes the meaning of constant and continuous. The persistent bias may persist for a period of time that is much longer than other characteristic times of the system. For example, the period of time may be much longer than the relaxation and dephasing times of the tunable qubit. The period of time may be a period of minutes, hours, or days. The period of time may continue for the length of time that the temperature of the system is maintained below the critical temperature of the superconducting material of the superconducting loop (e.g., inductive elements of the flux bias coil).

While some forms of coupling in qubits, such as thermal coupling, can be addressed by isolation of the quantum computer from its environment, for example mechanical vibration isolation and thermal isolation, other forms of coupling, such as electromagnetic coupling, can be more challenging. One form of electromagnetic coupling arises from charge noise, which is not trivial to shield. Charge fluctuations occur constantly in most materials, as the electrons in their orbits around atoms cause ephemeral regions of relatively positive and negative charge. This charge noise arises from the materials themselves and couples electromagnetically with the atoms of the qubits. Charge noise can thus cause decoherence to occur, as the electromagnetic interactions cause unpredictable changes to the states of the qubits.

In one aspect, the time that it takes for decoherence to occur is a measure of the viability of a quantum computing architecture. Larger objects generally decohere very quickly, as they have many interactions with their surrounding environments. The longer a quantum computer can maintain coherence, the more feasible it is to perform useful computations with that quantum computer. Finding ways to delay decoherence is therefore salient in the realm of quantum computing.

As used herein, the term “flux control” of a qubit generally refers to adjusting the frequency of a qubit by applying a relatively small amount of magnetic field to certain regions of the qubit. The magnetic field is created by e.g., providing direct current (DC) or a pulse of current through a so-called “flux bias line” associated with the qubit. For example, in known approaches, a flux bias line may be connected to ground, which is used as a return path for the current. When a current is applied, a magnetic field can be created. In some scenarios, static bias current can be applied. In other scenarios, the bias current can be altered to provide current ramps or pulses. The more qubits are on a chip, the more flux control currents are flowing to control qubits' frequencies, resulting in various parasitic effects that should be dealt with for better and reduced image currents. The ground may not be well defined. For example, there may be cuts in the ground, different wire bonds coupled thereto, etc., which render the ground path somewhat unpredictable in terms of impedance, capacitance, and image currents. Accordingly, when controlling multiple qubits, flux bias may lead to crosstalk between qubits via the ground plane, something that should be minimized.

In quantum processors that use flux tunable elements, there are various ways to bring in the biasing flux used to tune them in situ. In cases that involve individual control of different tunable elements on chip, these designs are usually some forms of small coil routed into/onto the processor itself. It is desirable that such coils have substantially low (e.g., minimal) crosstalk to other flux sensitive components that may be located nearby on the chip. As mentioned previously, these flux bias signals typically, but not always, have a bandwidth of <1 GHz. In order to support these time varying flux pulses, it is desirable that the flux coils reduce (e.g., minimize) sources of parasitic inductance and capacitance as much as possible, as these parasitic can introduce significant time domain distortion/dispersion to the applied flux pulses.

The teachings herein provide structures that that reduce crosstalk between qubits and are ultimately more resilient against quantum decoherence. In one aspect, there are plane-breaking elements, such as vias or bump bonds, that help form a (e.g., quadrupole) coil that can be differentially driven, rather than relying on ground terminated single ended lines. Such approach facilitates avoiding injecting current into the ground plane of the bias coil and/or SQUID that can result in uncontrolled parasitic inductances (both mutual and self). In one aspect, the teachings herein enable the use of multiturn coils in order to significantly increase the mutual inductance between the bias coil and the SQUID. The techniques described herein may be implemented in a number of ways. Example implementations are provided below with reference to the following figures.

### Example Multi-Plane Quadrupole Flux Bias Coils

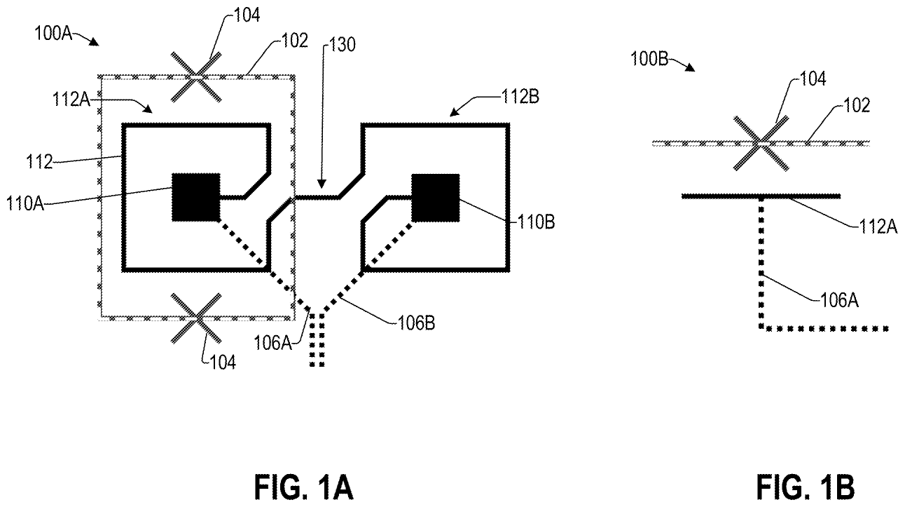

Reference now is made to FIG. 1A and 1B, which illustrate an example superconducting structure that uses a differential drive and a counter-wound coil to achieve reduced parasitic interference between qubits, consistent with an illustrative embodiment. More specifically, FIG. 1A provides a top-down view 100A and FIG. 1B provides a side view of 100B a superconducting structure of a multi-plane differential quadrupole flux bias coil, consistent with an illustrative embodiment.

In various embodiments, the superconducting structure of FIGS. 1A and 1B can be single ended or differentially controlled. Differential control includes the benefit of helping eliminate some of the parasitics with respect to how the induced field couples to the ground plane and induces image currents. The superconducting structure of FIG. 1A includes a superconducting interference device (SQUID) loop 102. A SQUID can be described as a sensitive magnetometer that can detect sensitive magnetic fields, based on superconducting loops that include Josephson junctions (e.g., 104).

There is counter-wound flux bias coil 112, which may be differential. Accordingly, the counter-wound flux bias coil has a first portion 112A (sometimes referred to herein as a first inductive element of the flux bias coil) that is wound in a first direction (e.g., counterclockwise) around a first landing pad 110A and then continues to wrap around a second landing pad 110B in a second direction (e.g., clockwise) with a second portion 112B (sometimes referred to herein as a second inductive element of the flux bias coil). As illustrated in FIG. 1A, when described with respect to the pads 110A, 110B, the flux bias coil is wound in a first direction (e.g., counterclockwise) and then meets at a center point 130 between the two landing pads 110A and 100B. In one embodiment, the first and second inductive elements 112A/B of the flux bias coil 112 comprise a superconducting material having a critical temperature that is a lower temperature than a critical temperature of any superconducting material of the tunable qubit. In operation, the superconducting loop can provide a DC, pulsed, or combined DC and pulsed bias to a tunable qubit. A superconducting loop can also utilize persistent circulating currents to provide such a flux bias.

Connecting to the flux bias coil 112 involves a path that is non-planar to the flux bias coil 112 using landing pads 110A and 110B to connect to elements that enable breaking the plane and to avoid shorting or interfering with the operation of the flux bias coil 112. In this regard, a via, thru silicon via, bump bond, etc., can be used to electrically couple flux bias lines 106A and 106B to their corresponding landing pads 110A and 110B, respectively. For example, the flux bias lines 106A and 106B are farther into the page than the landing pads 110A and 110B. This concept can be better understood in view of FIG. 1B, which illustrates a flux bias line 106A that leads to the landing pad 110A and ultimately the inductive element. The flux bias lines 106A and 106B provide connections to the current bias supply (not shown), which differentially drives the two ports of the SQUID 100A by way of the landing pads 110A and 110B. Although the flux bias lines 106A and 106B are illustrated by way of example to be straight lines in FIGS. 1A and 1B, this does not necessarily imply a straight line. It will be understood that any suitable geometry of such a “line” may be used according to various embodiments of the present disclosure.

With continued reference to FIG. 1A, the left flux bias line 106A may be for a positive current and the right flux bias line 106B may be for a negative current. For example, a positive (e.g., off-chip) current goes through the flux bias line 106 A towards the landing pad 110A. There may be a type of via that electrically connects the flux bias line 106A to the landing pad 110A. This current continues in a first direction (e.g., counterclockwise in the example of FIG. 1A) around the flux bias coil 112). Accordingly, in view of the “right hand rule for magnetic field” this current generates a magnetic field that is in a direction that is outside the page (e.g., orthogonal to the surface of the chip), which is picked up by the SQUID loop 102. The amount of current provided affects the inductance of the SQUID loop 102.

Accordingly, the first inductive element 112A (e.g., superconducting loop) creates a magnetic field that can tune a frequency of a tunable qubit. Often, only a very small tuning of the qubit frequency is sufficient to avoid frequency collisions. The tuning is conventionally achieved by applying a magnetic flux to the tunable qubit using the flux bias line 106A. However, the flux bias line 106A can introduce noise into the system, which can result in dephasing of the tunable qubit. Even small fluctuations in the bias current that is used to control the frequency of the tunable qubit can have a derogatory effect on the qubit's coherence. In one embodiment, each of the inductive elements discussed herein can create a persistent magnetic field that tunes the frequency of a tunable qubit.

To offset the challenges discussed hereinabove, the bias current continues to the right portion of the flux bias coil 112 and now travels in an opposite direction (e.g., clockwise) towards the second landing pad 110B, thereby inducing a magnetic field into the page (e.g., orthogonal to the surface of the chip). The magnetic fields induced by the first inductive element 112A and the second inductive element form a quadrupole magnetic field which decreases in strength rapidly as you move away from the bias coil. This reduces stray coupling to other flux tunable elements that may be nearby, thus reducing crosstalk. It also reduces stray coupling to other electrical elements on chip which may not be flux tunable, but will still present some parasitic load to the flux bias coil which lead to time-domain distortions of flux bias pulses.

It should be noted that the symmetry between the first inductive element 112A and the right inductive element 112B of the flux bias coil 112 is a salient consideration to avoid generating a magnetic field that is to be counteracted by generating a ground current in the surrounding ground plane. That is because, as mentioned previously, the surrounding ground plane may be unpredictable in architecture (e.g., geometry, number of vias, thickness, etc., of the surrounding ground plane).

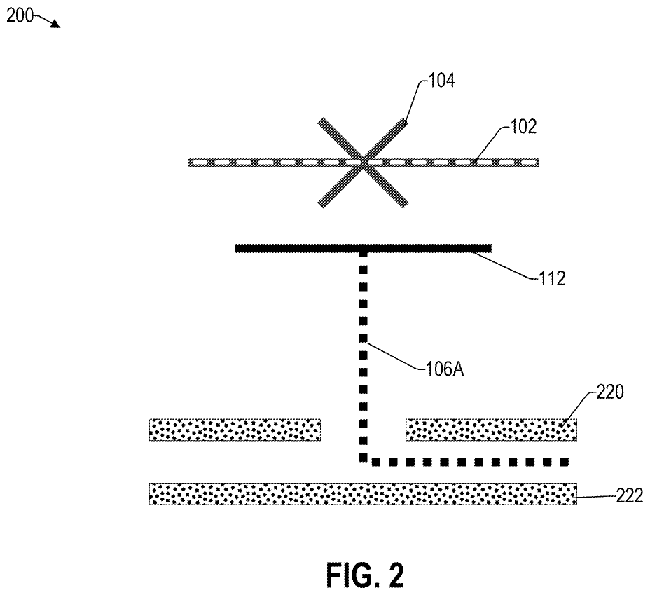

Reference now is made to FIG. 2, which illustrates another architecture of a superconducting interference device 200, where the lower layer wiring is encased in ground planes, consistent with an illustrative embodiment. For example, at least part of the flux bias line 106A is between a first ground layer (e.g., plane) 222 and a second ground layer (e.g., plane) 220, thereby providing better noise isolation (e.g., preventing signal interference and crosstalk). While the example of FIG. 2 illustrates the flux bias line in the context of a strip-line, in one embodiment the sides of the flux bias line 106A are also protected by ground wiring (e.g., appropriate continuous vertical structure such as a via between the two ground layers 220 and 222, thereby providing a more complete enclosure of the flux bias line 106A for even better signal integrity.

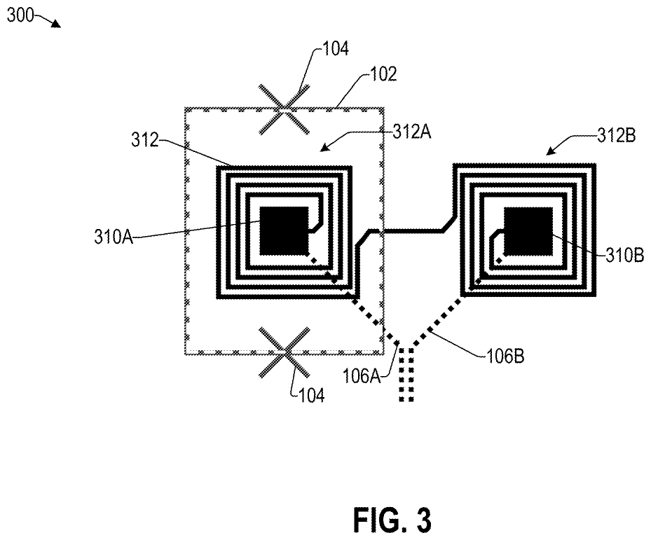

FIG. 3 illustrates an alternative embodiment of a superconducting inductive device 300 having inductive elements with additional loops in each coil, consistent with an illustrative embodiment. As the number of wounds (e.g., loops) in the coil 312 are increased the mutual inductance from the coil 312 to the squid 102 increases significantly. In one embodiment, the number of loops around the first landing pad 310A is the same as the number of loops around the second landing pad 310B, thereby providing a balanced arrangement. Architectures that have different number of loops around the first landing pad 110A and the second landing pad 110B are within the scope of the present disclosure. This configuration could be used in a situation where some controlled amount of image currents need to be induced in the surrounding ground plane. By virtue of having the flux bias coil 312 (which includes a first inductive element 312A and a second inductive element 312B) and the landing pads 310A and 310B on a separate plane than the flux bias lines 106A and 106B, different shapes and number of loops of the flux bias coil can be implemented. For example, in one embodiment, the flux bias line 312 can be substantially circular or octagonal and have several loops.

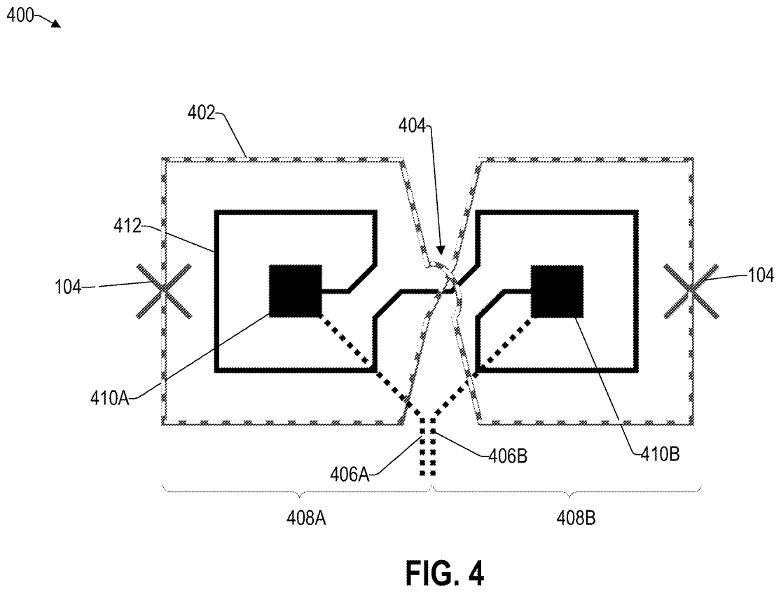

Reference now is made to a FIG. 4, which illustrates a top view of a gradiometric SQUID device 400, consistent with an illustrative embodiment. FIG. 4 a SQUID loop 402 that encompasses both loops of the flux bias coil 412. In one embodiment, there is a twist 404 in a center portion of the SQUID loop 402.

For example, the left flux bias line 406A may be for a positive current and the right flux bias line 406B may be for a negative current (e.g., return path of the current). A positive direct current (DC) or a pulse of current (e.g., from an off-chip source) can go through the flux bias line 406A towards the first landing pad 410A. In one embodiment, the bias is persistent. There may be a type of via that electrically connects the flux bias line 406A to the landing pad 410A. This current continues in a first direction (e.g., counterclockwise in the example of FIG. 4A) around the flux bias coil 412). Accordingly, this current generates a magnetic field that is in a direction that is outside the page, which is picked up by the first (e.g., left) portion 408A of the SQUID loop 402.

The current continues to the second (e.g., right) portion 408B of the flux bias coil 412 and now travels in an opposite direction (e.g., clockwise) towards the second landing pad 410B, thereby inducing a magnetic field into the page (e.g., which is orthogonal to the surface of the chip). Thus, the two loops 408A and 408B of the flux bias coil 412 are used to make a quadrupole filed. The SQUID 402 is arranged such that it couples directly to the quadrupole field. By virtue of the twist 404 in the SQUID loop 402, both halves of the induced magnetic field of the bias current can be used (e.g., thereby providing a doubling effect of the magnetic field instead of a cancellation effect).

### Example Process for Tuning a Qubit Device

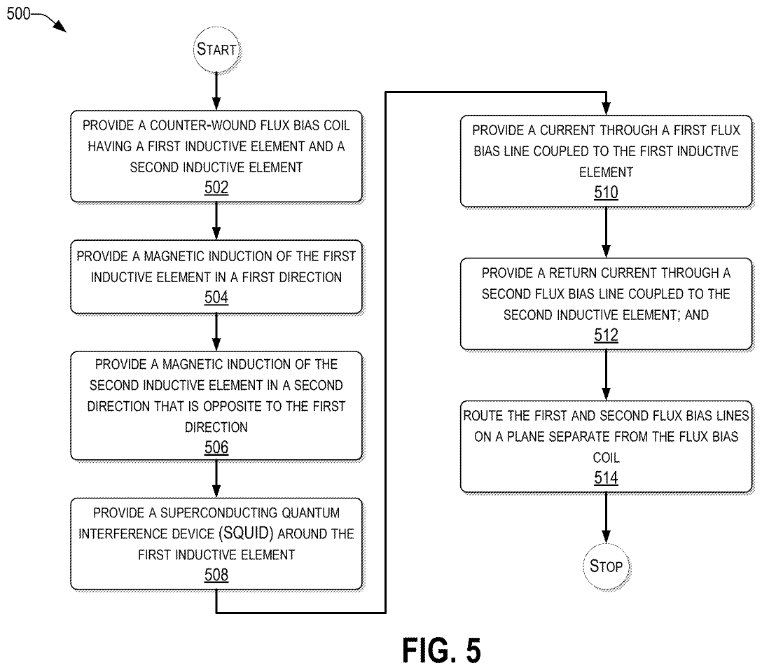

With the foregoing discussion of different flux bias coil systems, it may now be helpful to discuss a process of tuning a qubit device. In this regard, reference is made to FIG. 5, which provides a method 500 of tuning a qubit device, consistent with an illustrative embodiment.

At block 502, a counter-wound flux bias coil having a first inductive element and a second inductive element is provided.

At block 504, a magnetic induction of the first inductive element in a first direction is facilitated.

At block 506, a magnetic induction of the second inductive element in a second direction that is opposite to the first direction is facilitated.

At block 508, a superconducting quantum interference device (SQUID) is provided around the first inductive element.

At block 510, a current is provided through a first flux bias line coupled to the first inductive element.

At block 512, a return current is provided through a second flux bias line coupled to the second inductive element.

At block 514, the first and second flux bias lines are routed on a plane separate from the flux bias coil.

While the manufacture of a single multi-plane differential quadrupole flux bias coil is described for the purposes of discussion, it will be understood that other configurations, as well as those supporting multiple qubits are supported by the teachings herein. The method as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip may be mounted in a single chip package (such as a plastic carrier, with leads that are affixed to a motherboard or other higher-level carrier) or in a multichip package (such as a ceramic carrier that has either or both surface interconnections or buried interconnections). In any case, the chip can then be integrated with other chips, discrete circuit elements, and/or other signal processing devices as part of either (a) an intermediate product, such as a motherboard, or (b) an end product. The end product can be any product that includes integrated circuit chips, ranging from low-end applications, such as toys, to advanced computer products having a display, a keyboard or other input device, and a central processor.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A structure, comprising:
a flux bias coil having a first inductive element and a second inductive element, wherein a magnetic induction of the first inductive element is opposite to a magnetic induction of the second inductive element;
a superconducting quantum interference device (SQUID) within a footprint of the first inductive element;
a first flux bias line coupled to the first inductive element; and a second flux bias line coupled to the second inductive element,
wherein a routing of the first and second flux bias lines is on one or more planes separate from the flux bias coil.

2. The structure of claim 1, wherein the first inductive element is in series with the second inductive element.

3. The structure of claim 1, wherein a number of loops in each inductive coil is greater than 1.

4. The structure of claim 1, wherein the first inductive element is on a first plane and the second inductive element is on a second plane that is separate from the first plane.

5. The structure of claim 1, wherein a first landing pad coupled to the first inductive element and a second landing pad coupled to the second inductive element are each on a plane that is separate from the first and second bias lines coupled to the first and second landing pads, respectively.

6. The structure of claim 1, wherein the structure is configured to be controlled differentially.

7. The structure of claim 1, wherein structure is a quantum structure configured to be operated in a cryogenic environment.

8. The structure of claim 1, wherein the SQUID encompasses the first inductive element but not the second inductive element.

9. The structure of claim 1, wherein the SQUID encompasses both the first inductive element and the second inductive element.

10. The structure of claim 9, wherein the SQUID has a twist at a center portion of its loop to create a quadrupole field.

11. The structure of claim 1, wherein the first and second flux bias lines are each placed between a first ground layer and a second ground layer.

12. A tunable qubit device, comprising:
a counter-wound flux bias coil having a first inductive element and a second inductive element, wherein a magnetic induction of the first inductive element is opposite to a magnetic induction of the second inductive element;
a superconducting quantum interference device (SQUID) within a footprint of the first inductive element;
a first flux bias line coupled to the first inductive element; and
a second flux bias line coupled to the second inductive element,
wherein a routing of the first and second flux bias lines is on one or more planes separate from the flux bias coil.

13. The tunable qubit device of claim 12, wherein the first inductive element is in series with the second inductive element.

14. The tunable qubit device of claim 12, wherein the first inductive element is on a first plane and the second inductive element is on a second plane that is separate from the first plane.

15. The tunable qubit device of claim 12, wherein the flux bias coil is counter-wound and configured to be controlled differentially.

16. The tunable qubit device of claim 12, wherein quantum structure is configured to be operated in a cryogenic environment.

17. The tunable qubit device of claim 12, wherein the SQUID encompasses both the first inductive element and the second inductive element.

18. The tunable qubit device of claim 17, wherein the SQUID has a twist at a center portion of its loop to create a quadrupole field.

19. A method of tuning a qubit device, comprising:
providing a flux bias coil having a first inductive element and a second inductive element;
providing a magnetic induction of the first inductive element in a first direction;
providing a magnetic induction of the second inductive element in a second direction that is opposite to the first direction;
providing a superconducting quantum interference device (SQUID) within a footprint of the first inductive element;
providing a current through a first flux bias line coupled to the first inductive element;
providing a return current through a second flux bias line coupled to the second inductive element; and
routing the first and second flux bias lines on a plane separate from the flux bias coil.

20. The method of claim 19, further comprising coupling the first inductive element in series with the second inductive element.

21. The method of claim 19, wherein the first inductive element is on a first plane and the second inductive element is on a second plane that is separate from the first plane.

22. The method of claim 19, further comprising:
the SQUID encompassing both the first inductive element and the second inductive element; and
providing a twist, a center portion of a loop of the SQUID, to create a quadrupole field.

23. A quantum computer device, comprising:
a refrigeration system under vacuum comprising a containment vessel;
a qubit chip housed within a refrigerated vacuum environment defined by the containment vessel, wherein the qubit chip comprises a plurality of tunable qubit devices; and
a plurality of electromagnetic waveguides arranged within the refrigerated vacuum environment configured to direct electromagnetic energy to and receive electromagnetic energy from at least a selected one of the plurality of tunable qubit devices;
wherein each of the plurality of tunable qubit devices comprises:
a flux bias coil having a first inductive element and a second inductive element, wherein an induction of the first inductive element is opposite to an induction of the second inductive element;
a superconducting quantum interference device (SQUID) around the first inductive element;
a first flux bias line coupled to the first inductive element; and
a second flux bias line coupled to the second inductive element,
wherein a routing of the first and second flux bias lines is on one or more planes separate from the flux bias coil.

24. The quantum computer device of claim 23, wherein:
the first inductive element is in series with the second inductive element; and
a first landing pad coupled to the first flux bias line and a second landing pad coupled to the second flux bias line are each on a plane that is separate from the first and second bias lines coupled to the first and second landing pads, respectively.

25. The quantum computer device of claim 23, wherein:
the SQUID encompasses both the first inductive element and the second inductive element; and
the SQUID has a twist at a center portion of its loop to create a quadrupole field.
